(19) United States
(12) Patent Application Publication
(10) Pub. No.: US 2006/0035502 A1
(43) Pub. Date: Feb. 16, 2006

(54) MODULAR BIN POWERSTRIP ASSEMBLY FOR A VEHICLE

(75) Inventors: John M. Tiesler, Harrison Township, MI (US); Jim Mestemaker, Lambertville, MI (US)

Correspondence Address: JOHN A. ARTZ, ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 10/710,897

(22) Filed: Aug. 11, 2004

(51) Int. Cl. H01R 13/625

(52) U.S. Cl. 439/340

(57) ABSTRACT

A vehicle overhead module powerstrip assembly (14) includes an overhead attachment strip (40), an electrically conductive strip (44), and a modular connector (48). The overhead attachment strip (40) is configured to couple to a vehicle overhead structure (28). The electrically conductive strip (44) is coupled to the attachment strip (40). The modular connector (48) is configured to couple an overhead electronic module (18) to the electrically conductive strip (44). The modular connector (48) includes electrical contacts (46) that have multiple attachment positions along the electrically conductive strip (40).

### BACKGROUND OF INVENTION

The present invention relates to interior overhead vehicle assemblies and consoles. More particularly, the present invention relates to the supplying of electrical power to a modular bin within a configurable console of a vehicle.

Modern vehicles typically include an overhead console assembly. The overhead console assembly is generally an elongated structure disposed along a center longitudinal axis of a headliner. The headliner includes an upper surface mounted to an interior roof structure of the vehicle and a lower surface having an overlay applied thereon. The overhead console is mounted to the lower surface and provides additional storage space for items, such as eyeglasses, garage door openers, audio cassettes, and compact discs. The overhead console also may provide amenities or electronic accessories, such as overhead lights, heating, ventilation, and air-conditioning system (HVAC) controls, audio and video displays and controls, compasses, and temperature displays.

Current overhead console assemblies include a series of accessory compartments or modules for storing and containing the above-stated items and accessories. Some of the modules are pivotally mounted to the console to allow a passenger to stow and retrieve personal items from the compartment.

Traditional modules of overhead consoles are limited in use in that they are incapable of being repositioned relative to each other without a complete rebuild of the console. Fixed modules restrict passengers from rearranging the position of the modules based on driver and passenger preferences. Also, stored items within the fixed modules must be removed in order to transport the items to another vehicle location.

In addition, once an overhead console has been assembled in a vehicle, additional modules not previously installed cannot be added to the console without a complete rebuild. For example, an HVAC control module cannot be installed into the overhead console unless the console was originally built to house the HVAC module.

Modular overhead console assemblies have been created to allow for physical relocationing of overhead storage compartments. Although such an assembly allows for a vehicle passenger to change the location of storage compartments, such an assembly does not allow for the relocating of electronic modules.

Thus, there exists a need for an improved modular overhead console assembly that allows for the relocating or repositioning of overhead console electronic modules.

### SUMMARY OF INVENTION

The present invention overcomes the above-stated disadvantages by providing a vehicle overhead module powerstrip assembly that includes an overhead attachment strip, an electrically conductive strip, and a modular connector. The overhead attachment strip is configured to couple to a vehicle overhead structure. The electrically conductive strip is coupled to the attachment strip. The modular connector is configured to couple an overhead electronic module to the electrically conductive strip. The modular connector includes electrical contacts that have multiple attachment positions along the electrically conductive strip.

The embodiments of the present invention provide several advantages. One such advantage is the ability to alter the positional arrangement of modules including electronic modules within an overhead console. Thus, electronic modules may be positioned as passengers of a vehicle desire without total reconstruction of the overhead console. This provides convenience in access of the overhead modules.

Another advantage provided by an embodiment of the present invention is the provision of flexible flanges that both apply pressure to electrical contacts of an electrically conductive modular connector and cover the electrical strips of an overhead module. The flanges cover the electrical strips prior to and after the attachment of the overhead module to an overhead console. This provides an esthetically pleasing overhead console, prevents contact between a passenger and the electrical strips, and aids in maintaining contact between the electrical contacts and the electrical strips.

Additionally, another advantage provided by an embodiment of the present invention is the provision of an electrically conductive modular connector and attachment strip for an overhead module that allow the module to be arranged in an infinite number of positions within an overhead console.

The present invention itself, together with further objects and attendant advantages, will be best understood by reference to the following detailed description, taken in conjunction with the accompanying drawing.

### BRIEF DESCRIPTION OF DRAWINGS

For a more complete understanding of this invention reference should now be had to the embodiments illustrated in greater detail in the accompanying figures and described below by way of examples of the invention wherein:

FIG. 1 is a perspective view of an overhead console of a vehicle in accordance with an embodiment of the present invention;

FIG. 2 is an isometric exploded perspective assembly view of an overhead console in accordance with an embodiment of the present invention;

FIG. 3 is a quarter sectional perspective view of an overhead module assembly in accordance with an embodiment of the present invention;

FIG. 4 is a top perspective view of an overhead module in accordance with an embodiment of the present invention;

FIG. 5 is a perspective view of an electrically conductive modular connector of an overhead module in accordance with an embodiment of the present invention;

FIG. 6 is a cross-sectional view of the modular connector of FIG. 5 coupled to an overhead attachment strip in accordance with an embodiment of the present invention;

FIG. 7 is a cross-sectional side view of an overhead attachment strip in accordance with an embodiment of the present invention;

FIG. 8 is a cross-sectional side view of an electrically conductive modular connector of an overhead module coupled to the attachment strip of FIG. 7 in accordance with another embodiment of the present invention; and

FIG. 9 is a method of altering the position arrangement of modules of an overhead console in accordance with an embodiment of the present invention.

### DETAILED DESCRIPTION

In each of the following figures, the same reference numerals are used to refer to the same components. While the present invention is described primarily with respect to a reconfigurable overhead console for a vehicle, the present invention may be adapted to various vehicle consoles including fore, center, and aft located consoles, and other vehicle consoles known in the art. The present invention may be applied to ground-based vehicles, aeronautical vehicles, watercraft, and other vehicle applications known in the art.

In the following description, various operating parameters and components are described for one constructed embodiment. These specific parameters and components are included as examples and are not meant to be limiting.

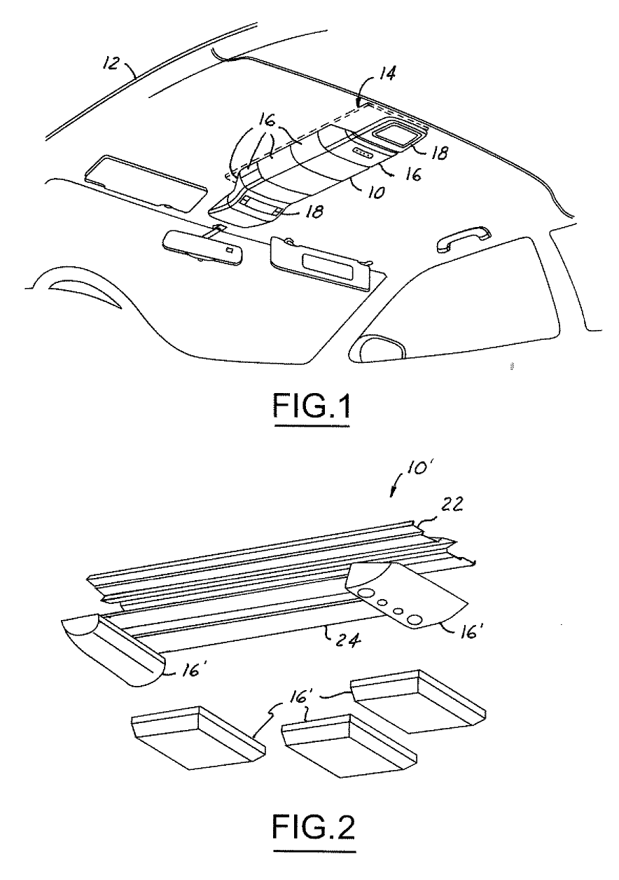

Referring now to FIG. 1, perspective view of an overhead console 10 of a vehicle 12 in accordance with an embodiment of the present invention is shown. The overhead console 10 includes a vehicle overhead module powerstrip assembly 14 and multiple overhead modules 16 including electronic overhead modules 18. The modules 16 may be manually removed from the powerstrip assembly 14 and rearranged in various positions relative to each other as desired by vehicle passengers. Examples of the power strip assembly 14 and components thereof are shown in and described with respect to FIGS. 2-8.

The modules 16 may be of various types, styles, shapes, and sizes. The modules 16 may include storage compartments, overhead lights, eyeglass holders, garage door opener holders and controls, audio cassette, CD, and DVD holders, heating, ventilation, or air-conditioning controls, audio and video displays and controls, compasses, and temperature displays, as well as other overhead modules known in the art.

Referring now to FIGS. 2-4, an isometric exploded perspective assembly view and a quarter sectional perspective view of an overhead console 10″, and a top perspective view of an overhead module assembly 20 are shown in accordance with multiple embodiments of the present invention. The overhead console 10″ includes an upper track 22 and a lower track 24 with multiple overhead modules 16″. The modules 16″ are rearrangeable on the tracks 22 and 24 and may receive power via the powerstrip assembly 14. The modules 16″ when snapped onto the tracks 22 and 24 are in contact with and may be slid along the powerstrip assembly 14 while maintaining electrical contact therewith.

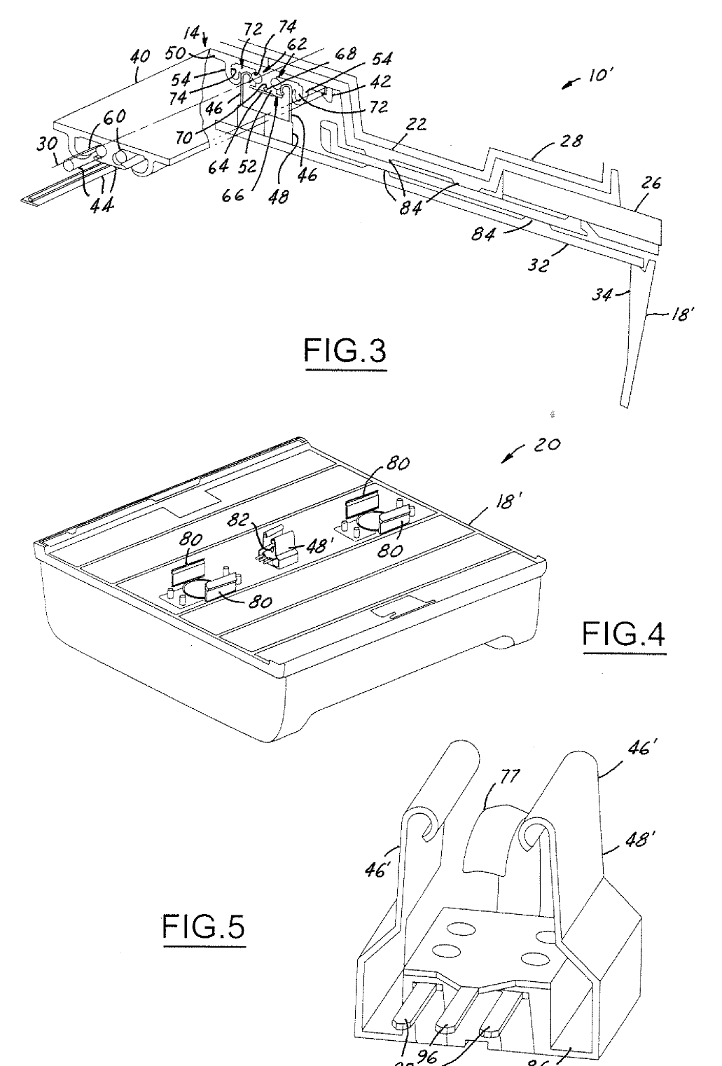

The overhead module assembly 20 is shown as one illustrated example and has an electronic overhead module 18″, which may be one of the overhead modules 16″. The upper track 22 is coupled to the powerstrip assembly 14, the headliner 26, and the vehicle support structure 28. A vehicle support structure 28 refers to a frame, a unibody, or a body structure of a vehicle. The lower track 24 is coupled to the electronic module 18″, the upper track 22, and the headliner 26. The electronic module 18″ is coupled to and receives power from the powerstrip assembly 14, which allows it to be in various positions longitudinally along a centerline of a vehicle, such as centerline 30. The electronic module 18″ may be in various fore and aft positions within the overhead console 10″. A lid 32 and a sidewall 34 of the electronic module 18″ are shown in FIG. 3.

The overhead module assembly 20 includes the powerstrip assembly 14 and the electronic module 18″. The powerstrip assembly 14 includes an overhead attachment strip 40, which may be coupled to the upper track 22 or to the support structure 28. The attachment strip 40, at least with respect to the embodiment of FIG. 3, is retained and attached to the upper track 22 via clips 42 (only one is shown). Multiple electrically conductive strips 44 reside within and are coupled to the attachment strip 40 and provide power to electrical contacts 46 of a modular connector 48. The modular connector 48 is coupled to the electronic module 18″ and may be manually snapped into or coupled to the attachment strip 40. The modular connector 18″ has an infinite number of attachment positions along the attachment strip 40.

The attachment strip 40 extends fore and aft longitudinally along the centerline 30. The attachment strip 40 may be a single extruded component as shown or may be formed of multiple components. The attachment strip 40 may be formed of various materials. In one sample embodiment, the attachment strip 40 includes a base 50 having a main center member 52 and a pair of flanges 54. In one example embodiment, the base 50 and the main center member 52 are formed of a polypropylene material and the flanges 54 are formed of both a polypropylene material and a saniprene material, although they may be formed of other materials. The base 50 and the flanges 54 are integrally extruded and formed as a single component using techniques known in the art. The polypropylene material provides a rigid structure, while the saniprene material provides a flexible structure.

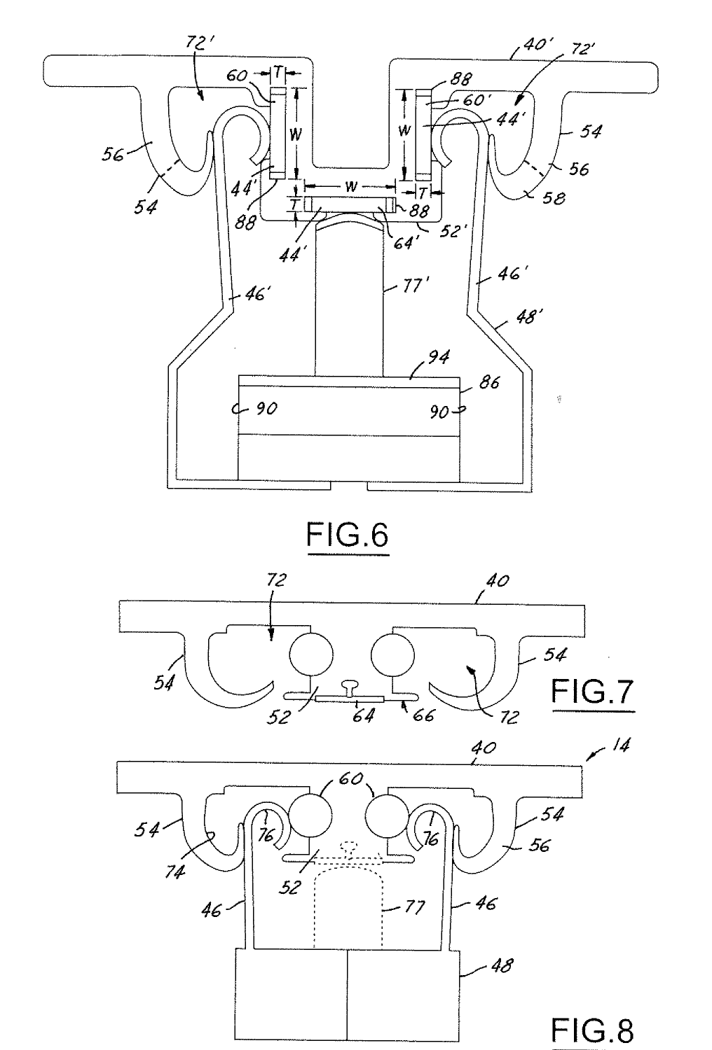

The flanges 54 have upper portions 56 and lower portions 58, which can be best seen in FIGS. 6 and 8. The upper portions 56 are formed of the polypropylene material and the lower portions 58 are formed of the saniprene material. The lower portions 56 are formed of a flexible material such that they may be deflected to allow insertion of the vertical contacts 46 into the attachment strip 40 and connection with the conductive strips 60. In the embodiment as shown, the flanges 54 are curled inward toward the center member 52 are deflected by and apply pressure on the vertical contacts 46. The flanges 54 apply pressure on the electrical contacts 46 to aid in maintaining contact between the contacts 46 and the associated conductive strips, such as strips 60. The flanges 54 also aid in preventing body parts of a passenger, such as fingers of the passenger, from contacting the conductive strips 60. The flanges 54 in addition provide an esthetically pleasing look to the overhead console 10″ when overhead modules, such as electronic module 18″, are removed therefrom by covering and hiding from passenger view the conductive strips 60.

The conductive strips 44 also extend fore and aft longitudinally along the centerline 30. The conductive strips 44 may also be of various types, styles, sizes, and shapes. The conductive strips 44 may be formed at least partially of brass, copper, aluminum, a half hard brass, or some other conductive material known in the art and may be controlled with the attachment strip 40. Two examples of the conductive strips 44 are shown in FIGS. 3 and 6-8. Round or cylinder strips are shown in FIGS. 3, 7, and 8. Rectangular or flat strips are shown in FIG. 6. The conductive strips 44 may be selected based on ease of manufacturing and availability or commonality thereof.

In one embodiment of the present invention, rectangular strips are utilized having a width W of approximately 4-5 mm and a thickness T of approximately 0.5 mm. The width and thickness dimensions W and T are shown for strips 44″ in FIG. 6. Two positively charged conductive strips, such as conductive strips 60, are mounted within vertical recessed portions 62 of the center member 52. A third negatively or neutrally charged strip 64, such as a ground strip, a common strip, or a return strip, is coupled horizontally along a lower flat portion 66 of the center member 52. The strips 44 may be adhesively coupled to the center member 52 or coupled via some other technique known in the art. For example, the ground strip 64 may have an attachment tab 68, as shown, that may be depressed or snapped into a ground channel 70 of the center member 52.

The modular connector 48 has multiple electrical terminals or contacts. In one embodiment, the pair of contacts 46 extend vertically and are “hooked” to have spring characteristics. When coupling the contacts 46 to the attachment strip 40, the contacts 46 are inserted into contact channels 72 of the attachment strip 40, through the flanges 54, and are in contact with the conductive strips 60. The contact channels 72 are formed via channel surfaces 74 of the attachment strip 40 and the conductive strips 60. The hooked areas 76 of the contacts 46 may be compressed when inserted into the contact channels 72 and may remain at least somewhat compressed or relaxed and in a normal state when in the channels 72. When compressed the contacts 46 may apply additional pressure on the conductive strips 60. The contacts 46 also may have a physical spreading resistance therebetween, such that the contacts 46 are further separated when inserted into the contact channels 72, again increasing pressure of the contacts 46 on the conductive strips 60.

The modular connector 48 may also have a vertical ground contact 77, as shown in FIG. 8, which is in contact with the ground strip 64. The modular connector 48 may have any number of contacts and the contacts may be in various configurations, a couple of which are shown in FIGS. 3-8. In FIGS. 3, 7, and 8 the modular connector 48 is rectangular shaped and in FIGS. 4-6 the modular connector 48″ has an irregular U-shape.

Referring now primarily to FIG. 4, the module assembly 20 includes the modular connector 48″ and one or more molecule hanging attachment clips 80. The modular connector 48″ is coupled to the module 18″ via multiple vertical ribs 82 (only one is shown) that may be plastic welded to the connector 48″. The hanging attachment clips 80 may be in the form of two-way clips, sometimes referred to as “push push clips”. Approximately the same amount of pressure is applied to the attachment clips 80 to attach them to the lower track 24 as when removing them from the lower track 24. The hanging attachment clips 80 may be formed of steel or some other rigid material or materials known in the art.

Referring again to FIG. 3, pads 84 may be located between the tracks 22 and 24 and the module 18″. The pads 84 stabilize, separate, and prevent rattling of the tracks 22 and 24 and prevent rattling of the module assembly 10″. The pads 84 may be of various types, styles, shapes, and sizes, and may be formed of various materials. In one embodiment of the present invention, felt pads are utilized. Any number of pads 84 may be used.

Referring now to FIGS. 5 and 6, a perspective view of the electrically conductive modular connector 48″ and a cross-sectional view of the modular connector 48″ coupled to an overhead attachment strip 40″ are shown in accordance with an embodiment of the present invention. As stated above, the modular connector 48″ is irregularly U-shaped. The modular connector 48″ has a pair of vertical electrically conductive positive contacts 46″ and a vertical ground contact 77″, which are separated by an insulator stack or block 86. The attachment strip 40″ is similar to that shown in FIG. 3, except the center member 52″ is altered to accommodate rectangular conductive strips as opposed to circular conductive strips. Also, the center member 52″ is U-shaped to minimize the amount of material utilized to form the attachment strip 40″. The center member 52″ has three rectangular slots 88 wherein the rectangular strips 44′ reside.

The vertical contacts 46″ extend within the channels 72″ and are in contact with the vertical strips 60″. The vertical contacts 46″ extend around the sides 90 of and are coupled to the insulator box 86. The vertical contacts 46″ are coupled to and may be integrally formed with positive or end terminals 92. The ground contact 77″ is pressed against the ground strip 64″ and is coupled to a ground plate 94. The ground plate 94 resides on the insulator block 86 and is coupled to a ground terminal 96. The ground contact 77″, the ground plate 94, and the ground terminal 96 may be formed as a signal unit as shown or may be separate components. The ground contact 77″ extends about the center of the connector and curls inward in a fore and aft direction. The ground contact 77″ also has spring characteristics such that it is at least partially in compression when in contact with the ground strip 64″. The terminals 92 and 96 extend horizontally and protrude from the modular connector 48″. An electrical connector (not shown) may be attached to the terminals 92 and 96 and used to supply power to electronic devices within the associated electronic module.

The contacts 46″ and 77″ and the terminals 92 and 96 may be formed of conductive materials, such as those mentioned above with respect to the conductive strips 44. In one embodiment, the contacts 46″ and 77″ are formed of 1050 spring steel and are zinc plated.

The vertical contacts 46″, the insulator box 86, and the ground plate 94 may have holes 98 extending therethrough for which module ribs, such as rib 82, may be inserted and attached thereto. The holes 98 may be of various sizes and shapes, which may correspond to the sizes and shapes of the ribs. The holes 98 may also be “keyed” such that the modular connector 48″ can only be coupled to the module 18″ in one or more desired positions. The module ribs may be plastic welded or attached via some other technique known in the art to the vertical contacts 46″, the insulator box 86, and the ground plate 94.

Referring now to FIGS. 7 and 8, a cross-sectional side view of the overhead attachment strip 40 and a cross-sectional side view of the electrically conductive modular connector 48 coupled thereto are shown in accordance with an embodiment of the present invention. The overhead attachment strip 40 and the modular connector 48 are similar to that shown in FIG. 3. The attachment strip is shown in FIG. 7 in a module-removed state and in FIG. 8 in a module stowed state. Notice that the flanges 54 cover a majority of the conductive strips 60 when in the relaxed state and are bent or compressed when in the normal or module stowed state. Although not shown as such, the flanges 54 may be in contact with the center member 52 when in the relaxed state.

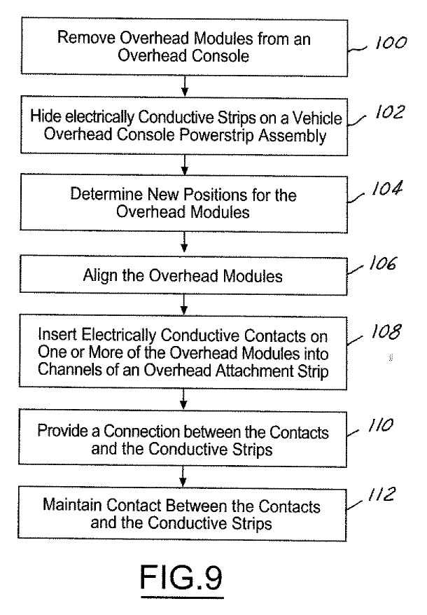

Referring now to FIG. 9, a method of altering the position arrangement of overhead modules of an overhead console in accordance with an embodiment of the present invention is shown.

In step 100, overhead modules are removed from an overhead console. The modular connectors of the electronic modules within the console, such as that of the electronic module 18″, are uncoupled from an overhead attachment strip, such as the attachment strip 40. In step 102, upon removal of the modules, electrically conductive strips on the attachment strip are covered and hidden from passenger view. The flanges of the attachment strip of the console are in the relaxed state.

In step 104, new positions of the modules are determined along the console including positions of the electronic modules. In step 106, the modules are aligned with their newly designated positions on the console. The modular connectors are aligned with their designated positions along the attachment strip.

In step 108, vertical conductive contacts, such as vertical conductive contacts 46 and 46″, on the electronic modular connectors are inserted into the corresponding contact channels, such as channels 72, on the attachment strip. In step 110, upon insertion of the contacts into the contact channels, the conductive contacts are in contact with the conductive strips. In step 112, contact between the conductive contacts and the conductive strips are maintained via the spring characteristics of the vertical conductive contacts, the separation resistance between the vertical conductive contacts, and the pressure exerted on the vertical conductive contacts by the flanges of the attachment strip.

The above-described steps are meant to be illustrative examples; the steps may be performed sequentially, synchronously, simultaneously, or in a different order depending upon the application.

The present invention provides a vehicle overhead module powerstrip assembly that allows for rearrangement of overhead modules within an overhead console without rebuild of the console. The powerstrip assembly allows electronic modules to be repositioned in an infinite number of positions along an overhead console. The present invention provides multiple features to maintain electrical contact between the module and power strip assembly and also accounts for esthetic satisfaction of and prevents electrical physical contact with a vehicle passenger.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

1. A vehicle overhead module powerstrip assembly comprising:
at least one overhead attachment strip configured to couple to a vehicle overhead structure;
at least one electrically conductive strip coupled to said at least one attachment strip; and
at least one modular connector comprising a plurality of electrical contacts having a plurality of attachment positions along said at least one electrically conductive strip, said at least one modular connector configured to couple an overhead electronic module to said at least one electrically conductive strip.

2. An assembly as in claim 1 wherein said at least one attachment strip is in the form of a single extruded component.

3. An assembly as in claim 1 wherein said at least one attachment strip comprises at least one flange that covers at least a portion of said at least one electrically conductive strip.

4. An assembly as in claim 3 wherein said at least one flange is flexible.

5. An assembly as in claim 3 wherein said at least one flange comprises at least one of polypropylene and saniprene.

6. An assembly as in claim 3 wherein said at least one flange applies pressure on said at least one modular connector to maintain electrical contact between said at least one electrically conductive strip and said at least one modular connector.

7. An assembly as in claim 1 wherein said at least one electrically conductive strip comprise:
a positively charged electrically conductive strip; and
a negatively charged electrically conductive strip.

8. An assembly as in claim 1 wherein said at least one electrically conductive strip extend in a fore and aft direction along a longitudinal centerline of a vehicle.

9. An assembly as in claim 1 wherein said plurality of electrical contacts comprises a spring loaded ground contact that is in contact with a ground strip of said at least one electrically conductive strip.

10. An assembly as in claim 1 wherein said at least one overhead attachment strip comprises a plurality of channels, at least a portion of said plurality of electrical contacts extend into said plurality of channels and are in contact with said at least one electrically conductive strip therein.

11. An assembly as in claim 1 wherein said plurality of electrical contacts comprise:
a first power contact; and
a second power contact having a physical spreading resistance relative to said first power contact to maintain electrical contact with said at least one electrically conductive strip.

12. An assembly as in claim 1 wherein said plurality of electrical contacts are slidable along said at least one electrically conductive strip.

13. An assembly as in claim 1 wherein said at least one overhead attachment strip further comprises a main center member, said at least one electrically conductive strip coupled to and extending along said main center member.

14. An assembly as in claim 1 wherein said at least one modular connector comprises at least one insulator separating said plurality of electrical contacts.

15. An assembly as in claim 14 wherein said at least one insulator comprises a plurality of module attachment holes.

16. A vehicle overhead console comprising:
at least one track;
at least one overhead electronic module transitional along said at least one track; and
at least one vehicle overhead module powerstrip assembly comprising;
at least one overhead attachment strip configured to couple to a vehicle overhead structure;
at least one electrically conductive strip coupled to said at least one attachment strip; and
at least one modular connector comprising a plurality of electrical contacts having a plurality of attachment positions along said at least one electrically conductive strip, said at least one modular connector configured to couple said at least one overhead electronic module to said at least one electrically conductive strip.

17. A console as in claim 16 wherein said at least one overhead attachment strip is coupled to said at least one track via at least one fastening device.

18. A console as in claim 16 wherein said at least one electronic module has an infinite number of module positions relative to said track and receives power from said at least one electrically conductive strip in each of said module positions.

19. A method of altering the arrangement of a plurality of overhead console modules of a vehicle comprising:
uncoupling at least one electrically conductive modular connector corresponding with the plurality of overhead console modules from at least one overhead attachment stri p;
determining a position of the at least one electrically conductive modular connector;
aligning the at least one electrically conductive modular connector with said at least one overhead attachment stri p;
inserting at least one electrical contact of said at least one electrically conductive modular connector into a plurality of channels of said at least one overhead attachment strip;
contacting said at least one electrical contact with at least one electrically conductive strip of said at least one overhead attachment strip; and
maintaining contact between said at least one electrical contact and said at least one electrically conductive strip.

20. A method as in claim 19 further comprising hiding at least a portion of said at least one electrically conductive strip.
